(19) United States
(12) Patent Application Publication
(10) Pub. No.: US 2026/0009959 A1
(43) Pub. Date: Jan. 8, 2026

(54) OPTICAL FIBER CABLE AND METHOD FOR MANUFACTURE

(71) Applicant: STERLITE TECHNOLOGIES LIMITED, Gurugram (IN)

(72) Inventors: Badri Gomatam, Gurugram (IN); Rubin Thomas, Gurugram (IN); Jivesh Krishna, Gurugram (IN); Sandeep Gaikwad, Gurugram (IN); Arun Gupta M, Gurugram (IN); Shubham Sachan, Gurugram (IN); Sai Chadaram Kishore, Gurugram (IN)

(21) Appl. No.: 19/260,126

(22) Filed: Jul. 3, 2025

(30) Foreign Application Priority Data
Jul. 3, 2024 (IN) IN202411051087

(51) Int. Cl. G02B 6/44; G02B 6/52

(52) U.S. Cl. CPC G02B 6/4432; G02B 6/448; G02B 6/52

(57) ABSTRACT

The present disclosure provides an optical fiber cable (10) comprising: one or more optical fibers (12, 12₁, 12₂, 12₃, 12₄); and a sheath (14) surrounding the one or more optical fibers (12, 12₁, 12₂, 12₃, 12₄). Moreover, the sheath (14) comprising a plurality of ribs (16₁, 16₂, 16₃, 16₄) and a plurality of grooves (18₁, 18₂, 18₃, 18₄) on an outer surface and extending along a length of the optical fiber cable (10). Further, the one or more grooves (18₁, 18₂, 18₃, 18₄) has a protuberant profile (20₁, 20₂, 20₃, 20₄) at the outer surface of the sheath substantially in the middle of the one or more grooves (18₁, 18₂, 18₃, 18₄) at one or more cross-sections of the optical fiber cable (10).

### CROSS-REFERENCE TO RELATED APPLICATIONS

The present application claims the benefit of Indian Application No. IN202411051087 titled “OPTICAL FIBER CABLE AND METHOD FOR MANUFACTURE” filed by the applicant on Jul. 3, 2025, which is incorporated herein by reference in its entirety.

### FIELD OF THE INVENTION

Embodiments of the present disclosure relate to the field of wireless communication networks, and in particular, relates to the optical fiber cable and a method for manufacturing the optical fibre and the optical fibre produced thereof.

### DESCRIPTION OF RELATED ART

An optical fiber network finds its presence in every region across the globe. The optical fiber network supports world-wide communication systems and ensures uninterrupted services related to voice calls, internet and the like. Optical fiber cables are the foundation for the optical fiber networks and link one optical fiber network to another optical fiber network. The optical fiber cables comprise optical transmission elements, i.e., optical fibers, that are responsible for linking the optical fiber networks.

Fiber optic communication systems deliver high bandwidth communication capabilities to customers. Optical fiber connectors are an important part of most fiber optic communication systems that allow two optical fibers to be quickly, optically connected without requiring a splice. Further, the fiber optic connectors can be used to optically interconnect two lengths of optical fiber. Also, it can be used to interconnect lengths of optical fiber to passive and active equipment.

There is an ever-increasing demand for high-speed or high-bandwidth communication channels for delivering high-speed data and video services. To meet this demand, telecommunications service providers are developing networks (sometimes referred to as outside plant networks) that extend the higher bandwidth of fiber optic components all the way to the end-user businesses and homes (referred to as premises).

An air blowing optical fiber cable installation technique is a method used for installing optical fiber cable into duct using compressed air. This technique involves propelling the optical fiber cable through a duct by the force of the air, reducing the physical strain on the optical fiber cable and minimizing the risk of damage during installation. However, to implement the air blowing optical fiber cable installation technique, specially designed optical fiber cable is needed.

European patent Application “EP3796060B1” discloses a specially designed optical fiber cable suited for use in the air blowing optical fiber cable installation technique is disclosed in. The optical fiber cable includes a sheath; and a core which is housed in the sheath and which has an intermittently-adhered optical fiber ribbon including a plurality of optical fibers and a plurality of adhesive portions for intermittently adhering the plurality of optical fibers in a longitudinal direction, with recesses and protrusions are formed so as to be disposed alternately in a circumferential direction on an outer circumferential surface of the sheath, and the recesses each include two connecting portions respectively connected to radial inner ends of two adjacent protrusions, and a bottom surface positioned between the two connecting portions.

Another European patent Application “EP3796060B1” discloses the optical fiber cable that has a cross-sectional area of the recesses within a range of 1.3 mm² or more and 4.8 mm² or less. The cross-sectional area of the recesses is a cross-sectional area of a space defined by a closed curve tangent to radial outer ends of the plurality of protrusions and all the recesses, is a difference in a cross-sectional area of the optical fiber cable with respect to a cross-sectional area of a virtual optical fiber cable having the closed curve that contacts with each radial outer end of the protrusions as an outer circumferential surface, and the closed curve is a circular shape or an elliptical shape of which center is a central axis of the optical fiber cable.

Yet another European patent Application “EP2579079A1” discloses specially designed optical fiber cable suited for use in the air blowing optical fiber cable installation technique. The optical fiber cable comprises at least one optical fiber unit (3) and a sheath (1) which is coated on the optical fiber unit (3); at least one non-metal wire bundle (2) is arranged between the sheath (1) and the optical fiber unit (3); the adjacent part of the optical fiber unit (3) comprises a reinforced rod (5) and a filling rope (6); water-blocking substances are filled among the optical fiber unit (3), the reinforced rod (5) and the filling rope (6); the optical fiber unit (3) internally comprises at least one optical fiber (4); the surface of the sheath (1) is provided with a plurality of convex or concave patterns (9); and letters are printed on the convex or concave patterns (9) and between the convex or concave patterns (9).

Yet another US patent application “U.S. Pat. No. 9,625,670B2” discloses specially designed optical fiber cable suited for use in the air blowing optical fiber cable installation technique. The optical fiber cable comprises a jacket having a hollow interior for accommodating one or more signal lines capable of transmitting data, voice, and/or control signals through the cable; and a plurality of outer grooves formed on an outer surface of the jacket and extending along an entire length of the cable, wherein, when a portion of the outer surface of the jacket contacts a duct in which the cable is deployed, a plurality of airflow passages are created within spaces defined by the plurality of outer grooves and an inner surface of the duct, and wherein the plurality of airflow passages are configured to allow continuous airflow around the outer surface of the jacket to facilitate deployment of the cable through the duct.

While the prior arts cover various solutions of optical fiber cable suited for use in the air blowing optical fiber cable installations, there still remains a scope for improvement.

There is still a need to provide an optical fiber cable suited for use in the air blowing optical fiber cable installation technique that can be installed efficiently by air blowing up to a distance of 1500 meters and seals properly for gas leakage test.

Accordingly, to overcome the disadvantages of the prior arts, there is a need for a technical solution that overcomes the above-stated limitations in the prior arts. The present invention provides an optical fiber cable and a method of manufacturing thereof.

### SUMMARY OF THE INVENTION

Embodiments of the present invention relates to an optical fiber cable comprising: one or more optical fibers and a sheath surrounding the one or more optical fibers. In particular, the sheath comprises a plurality of ribs and a plurality of grooves on an outer surface extending along a length of the optical fiber cable. Further, the one or more grooves has a protuberant profile at the outer surface of the sheath substantially in the middle of the one or more grooves at one or more cross-sections of the optical fiber cable.

In accordance with an embodiment of the invention, one or more pairs of two consecutive ribs have at most a first radially inward convex portion and a second radially inward convex portion.

In accordance with an embodiment of the invention, the first outermost points of the ribs being at a distance from center of the cable substantially equal to the outer radius of the optical fiber cable. In particular, the first outermost points of the ribs being at a first height H1, as taken from a line joining the first innermost points of the first radially inward convex portion of the rib and the second innermost points of the second radially inward convex portion of the rib. Moreover, a second outermost points of the protuberant profile of the grooves being at a second height H2, as taken from the line joining the first innermost points of the first radially inward convex portion of the groove and the second innermost points of the second radially inward convex portion of the groove.

In accordance with an embodiment of the invention, a first width of the plurality of ribs being W1, as taken along a circumferential direction of the optical fiber cable, a second width of the plurality of grooves being W2, as taken along a circumferential direction of the optical fiber cable. Further, a number of grooves are N1.

In accordance with an embodiment of the invention, a ratio between outer radius and W2 being in the range of 5 to 8.

In accordance with an embodiment of the invention, the second height H2 corresponding to the second outermost points of the protuberant profile of the grooves is in the range of 0.08 to 0.14 mm.

In accordance with an embodiment of the invention, the first height H1 corresponding to the first outermost points of the ribs is in the range of 0.2 to 0.3 mm. In a further embodiment of the invention, a ratio between N1 and outer radius being in the range of 2.4 to 4.

In accordance with an embodiment of the invention, a ratio between outer radius and W1 being in the range of 7 to 9.

In accordance with an embodiment of the invention, the one or more optical fibers comprise one or more loose fibers, one or more optical fiber ribbon, one or more intermittent bonded ribbon optical fibers, one or more fibers in one or more loose tubes, one or more fibers in one or more micro modules, one or more tight buffered fibers, one or more bundles of fibers, one or more bundles of optical fiber ribbons, and one or more bundles of intermittent bonded ribbon optical fibers.

Further, the optical fiber cable comprises one or more additional layers disposed between the one or more optical fibers and the sheath. In particular, the one or more bundles of intermittent bonded ribbon optical fibers are bound by one or more water swellable binders.

Another embodiment of the present invention relates to a method of manufacturing an optical fiber cable comprising steps of paying off one or more optical fibers; and extruding a sheath so as to surround the one or more optical fibers; the sheath comprising a plurality of ribs and a plurality of grooves on an outer surface and extending along a length of the optical fiber cable; the one or more grooves has a protuberant profile at the outer surface of the sheath substantially in the middle of the one or more grooves at one or more cross-sections of the optical fiber cable. Particularly, the one or more pairs of two consecutive ribs have at most a first radially inward convex portion and a second radially inward convex portion. Further, the sheath is extruded at a vacuum pressure of 60±5 mm Hg.

The foregoing objectives of the present invention are attained by employing an optical fiber cable that can be installed by air blowing optical fiber cable installation technique within a duct up to a distance of 1500 m with an average speed of about 50 to 60 m/min at an air pressure of 50±5 bar with a duct fill ratio (DFR) in the range of 30 to 70%.

### BRIEF DESCRIPTION OF DRAWINGS

To describe the technical solutions in the embodiments of the present invention or in the prior art more clearly, the following briefly describes the accompanying drawings required for describing the embodiments or the prior art. Apparently, the accompanying drawings in the following description merely show some embodiments of the present invention, and a person of ordinary skill in the art can derive other implementations from these accompanying drawings without creative efforts. All of the embodiments or the implementations shall fall within the protection scope of the present invention.

FIG. 1 is a pictorial snapshot illustrating a cross-sectional view of the optical fiber cable of an optical fiber enclosure in accordance with an embodiment of the present disclosure.

FIG. 2 is a pictorial snapshot illustrating a first close-up view of sheath portion of the optical fiber cable in accordance with an embodiment of the present disclosure;

FIG. 3 is a pictorial snapshot illustrating a second close-up view of sheath portion of the optical fiber cable in accordance with an embodiment of the present disclosure;

FIG. 4 is a pictorial snapshot illustrating a cross-sectional view of the optical fiber cable in accordance with another embodiment of the present disclosure;

FIG. 5 is a pictorial snapshot illustrating a cross-sectional view of the optical fiber cable of being placed within a duct in accordance with an embodiment of the present disclosure.

The optical fiber enclosure is illustrated in the accompanying drawings, which like reference letters indicate corresponding parts in the various figures. It should be noted that the accompanying figure is intended to present illustrations of exemplary embodiments of the present invention. This figure is not intended to limit the scope of the present invention. It should also be noted that the accompanying figure is not necessarily drawn to scale.

### DESCRIPTION OF EMBODIMENTS

Those skilled in the art will be aware that the present invention is subject to variations and modifications other than those specifically described. It is to be understood that the present invention includes all such variations and modifications. The invention also includes all such steps, features, compositions and compounds referred to or indicated in this specification, individually or collectively, and any and all combinations of any or more of such steps or features.

### Definitions

For convenience, before further description of the present invention, certain terms employed in the specification, and examples are collected here. These definitions should be read in the light of the remainder of the invention and understood as by a person of skill in the art. The terms used herein have the meanings recognized and known to those of skill in the art, however, for convenience and completeness, particular terms and their meanings are set forth below.

The articles “a”, “an” and “the” are used to refer to one or to more than one (i.e., to at least one) of the grammatical object of the article.

The terms “comprise” and “comprising” are used in the inclusive, open sense, meaning that additional elements may be included. It is not intended to be construed as “consists of only”. Throughout this specification, unless the context requires otherwise the word “comprise”, and variations such as “comprises” and “comprising”, will be understood to imply the inclusion of a stated element or step or group of element or steps but not the exclusion of any other element or step or group of element or steps.

The term “including” is used to mean “including but not limited to”. “Including” and “including but not limited to” are used interchangeably.

### The Following Brief Definition of Terms Shall Apply Throughout the Present Invention

Optical fiber cable includes a plurality of fibers and carries information in the form of data between two places using light technology. The optical fiber cable is a cable used for carrying light over long distances. Furthermore, the optical fiber cable may simply be used to transmit optical signals which may carry sensor data or communication data.

Duct fill ratio is the ratio between a cross sectional area of the optical fiber cable and an inner space of the duct in which the optical fiber cable is installed.

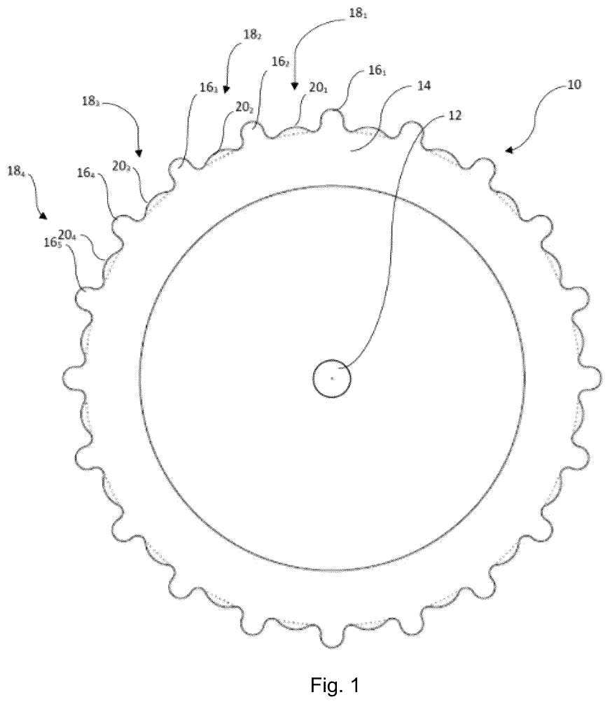

FIG. 1 is a pictorial snapshot illustrating a cross-sectional view of the optical fiber cable of an optical fiber enclosure in accordance with an embodiment of the present disclosure. The optical fiber cable (10) comprises an optical fiber (12); and a sheath (14) surrounding the optical fiber (12).

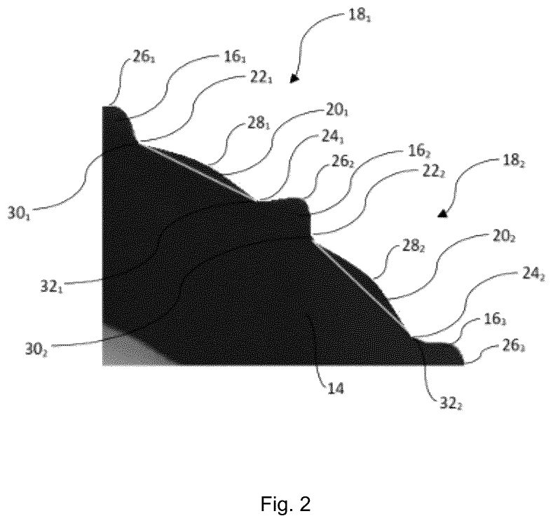

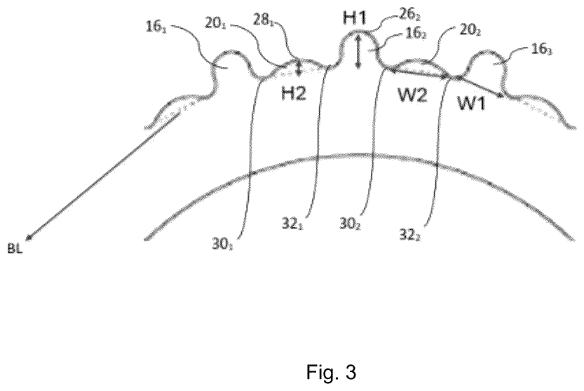

FIG. 2 and FIG. 3 are pictorial snapshots illustrating a first close-up view of sheath portion of the optical fiber cable (10) and a second close-up view of sheath portion (14) of the optical fiber cable in accordance with an embodiment of the present disclosure. In particular, the sheath (14) comprises a plurality of ribs (16₁, 16₂, 16₃, 16₄) and a plurality of grooves (18₁, 18₂, 18₃, 18₄) on an outer surface. Moreover, the plurality of ribs (16₁, 16₂, 16₃, 16₄) and a plurality of grooves (18₁, 18₂, 18₃, 18₄) extend along a length of the optical fiber cable (10). Further, a number of grooves (18₁, 18₂, 18₃, 18₄) may be N1.

In an embodiment of the invention, the one or more grooves (18₁, 18₂, 18₃, 18₄) has a protuberant profile (20₁, 20₂, 20₃, 20₄) at the outer surface of the sheath substantially in the middle of the one or more grooves (18₁, 18₂, 18₃, 18₄) at one or more cross-sections of the optical fiber cable (10). In particular, one or more pairs of two consecutive ribs (16₁, 16₂, 16₃, 16₄) have at most a first radially inward convex portion (22₁, 22₂, 22₃, 22₄) and a second radially inward convex portion (24₁, 24₂, 24₃, 24₄). Further, the second close-up view of the sheath (14) particularly shows the dimensions of certain portions of the sheath (14).

In accordance with an embodiment of the invention, the first outermost points (26₁, 26₂, 26₃, 26₄) of the ribs (16₁, 16₂, 16₃, 16₄) being at a distance from the center of the cable substantially equal to the outer radius of the optical fiber cable (10). In particular, the first outermost points (26₁, 26₂, 26₃, 26₄) of the ribs (16₁, 16₂, 16₃, 16₄) being at a first height H1, as taken perpendicular from a line joining a first substantially innermost points (30₁, 30₂, 30₃, 30₄) of the first radially inward convex portion (22₁, 22₂, 22₃, 22₄) of the respective rib (16₁, 16₂, 16₃, 16₄) and a second substantially innermost points (32₁, 32₂, 32₃, 32₄) of the second radially inward convex portion (24₁, 24₂, 24₃, 24₄) of the respective rib (16₁, 16₂, 16₃, 16₄).

Further, second outermost points (28₁, 28₂, 28₃, 28₄) of the protuberant profile (20₁, 20₂, 20₃, 20₄) of the grooves (18₁, 18₂, 18₃, 18₄) being at a second height H2, as taken perpendicular from the line joining the first substantially innermost points (30₁, 30₂, 30₃, 30₄) of the first radially inward convex portion (22₁, 22₂, 22₃, 22₄) of the respective groove (18₁, 18₂, 18₃, 18₄) and the second substantially innermost points (32₁, 32₂, 32₃, 32₄) of the second radially inward convex portion (24₁, 24₂, 24₃, 24₄) of the respective groove (18₁, 18₂, 18₃, 18₄).

In accordance with an embodiment of the invention, a first width of the plurality of ribs (16₁, 16₂, 16₃, 16₄) being W1, as length of the line joining a first substantially innermost points (30₁, 30₂, 30₃, 30₄) of the first radially inward convex portion (22₁, 22₂, 22₃, 22₄) of the respective rib (16₁, 16₂, 16₃, 16₄) and a second substantially innermost points (32₁, 32₂, 32₃, 32₄) of the second radially inward convex portion (24₁, 24₂, 24₃, 24₄) of the respective rib (16₁, 16₂, 16₃, 16₄).

In accordance with an embodiment of the invention, a second width of the plurality of grooves (18₁, 18₂, 18₃, 18₄) being W2, as length of the line joining the first substantially innermost points (30₁, 30₂, 30₃, 30₄) of the first radially inward convex portion (22₁, 22₂, 22₃, 22₄) of the respective groove (18₁, 18₂, 18₃, 18₄) and the second substantially innermost points (32₁, 32₂, 32₃, 32₄) of the second radially inward convex portion (24₁, 24₂, 24₃, 24₄) of the respective groove (18₁, 18₂, 18₃, 18₄).

Further, one or more ribs (16₁, 16₂, 16₃, 16₄) and one or more grooves (18₁, 18₂, 18₃, 18₄) of the optical fiber cable (10) may have a variation of up to 30% from the average dimensions of the one or more parameters H1, H2, W1, W2 at any cross-section of the cable. In another embodiment of the invention, the variation may be less than 10%. This variation in the parameters of one or more ribs or grooves may arise due to the variation in process parameters or design variations.

In accordance with an embodiment of the invention, a ratio between outer radius and W2 being in the range of 5 to 8. While several possible embodiments of the invention have been described above and illustrated in some cases, it should be interpreted and understood as to have been presented only by way of illustration and example, but not by limitation. It is believed that when the ratio between outer radius and W2 is below 5, the gap between adjacent ribs will increase, which will increase contact surface area between sheath and duct. Further, the sealing may not be proper when groove width is large and result in air leakage. Furthermore, without wishing to be limited to any specific theory, it is believed that when the ratio between outer radius and W2 is above 8, manufacturing of the desired profile of ribs and grooves may become challenging. If groove shape is not achieved, sealing may not be proper.

In accordance with an embodiment of the invention, the second height H2 corresponding to the second substantially outermost points (28₁, 28₂, 28₃, 28₄) of the protuberant profile (20₁, 20₂, 20₃, 20₄) of the grooves (18₁, 18₂, 18₃, 18₄) is in the range of 0.08 to 0.14 mm. While several possible embodiments of the invention have been described above and illustrated in some cases, it should be interpreted and understood as to have been presented only by way of illustration and example, but not by limitation, it is believed that when the second height H2 is below 0.08 mm, the sealing may not be proper. Also, without wishing to be limited to any specific theory, it is believed that when the second height H2 is above 0.14 mm, contact surface area may increase and drag force may reduce. This could lead to challenges in installing the optical fiber cable by the air blowing installation technique.

In accordance with an embodiment of the invention, the first height H1 corresponding to the first substantially outermost points (26₁, 26₂, 26₃, 26₄) of the ribs (16₁, 16₂, 16₃, 16₄) is in the range of 0.2 to 0.3 mm. While several possible embodiments of the invention have been described above and illustrated in some cases, it should be interpreted and understood as to have been presented only by way of illustration and example, but not by limitation. It is believed that when first height H1 is below 0.2 mm, corrugation may not be sufficient to reduce contact surface area and to increase the drag force. Also, without wishing to be limited to any specific theory, it is believed that when first height H1 is above 0.3 mm, a gap between the optical fiber cable and the duct may increase and sealing may not be proper.

In accordance with an embodiment of the invention, a ratio between N1 and outer radius being in the range of 2.4 to 4. While several possible embodiments of the invention have been described above and illustrated in some cases, it should be interpreted and understood as to have been presented only by way of illustration and example, but not by limitation, it is believed that when the ratio between N1 and outer radius is below 2.4, the number of grooves may not be sufficient to reduce contact surface area and increase drag force. Also, without wishing to be limited to any specific theory, it is believed that when the ratio between N1 and outer radius is greater than 4, manufacturing the optical fiber cable with the desired profile may become a challenge. Also, there may arise sealing complications.

In accordance with an embodiment of the invention, a ratio between outer radius and W1 being in the range of 7 to 9. While several possible embodiments of the invention have been described above and illustrated in some cases, it should be interpreted and understood as to have been presented only by way of illustration and example, but not by limitation, it is believed that when the ratio between outer radius and W1 is below 7, manufacturing the optical fiber cable with the desired profile may become a challenge. Also, without wishing to be limited to any specific theory, it is believed that when the ratio between outer radius and W1 is above 9, the number of grooves may not be sufficient to reduce contact surface area and increase drag force.

It may be noted that in order to observe the protuberant profile of the groove on an optical fiber cable, the following procedure may be followed:
Cut the cross-section of the cable orthogonal to its length to obtain a sample of 1-5 mm in length.
Place the sample for analysis under a microscope with 2.5× magnification to view the cross-sectional profile of the sheath, which includes ribs and grooves.
Draw a straight line connecting the substantially bottom ends which connects the rib and groove of two adjacent ribs.
If any trace of sheath material above the middle of a straight line is observed in curved shape (radially outward), with at least a height (related to height of outermost point 28 from the middle of straight line as defined in claim 3) of 80 micrometers, can be considered as a Protuberant shape. Middle of straight line is a portion spanning from the midpoint of line ±35% of line length in both direction.

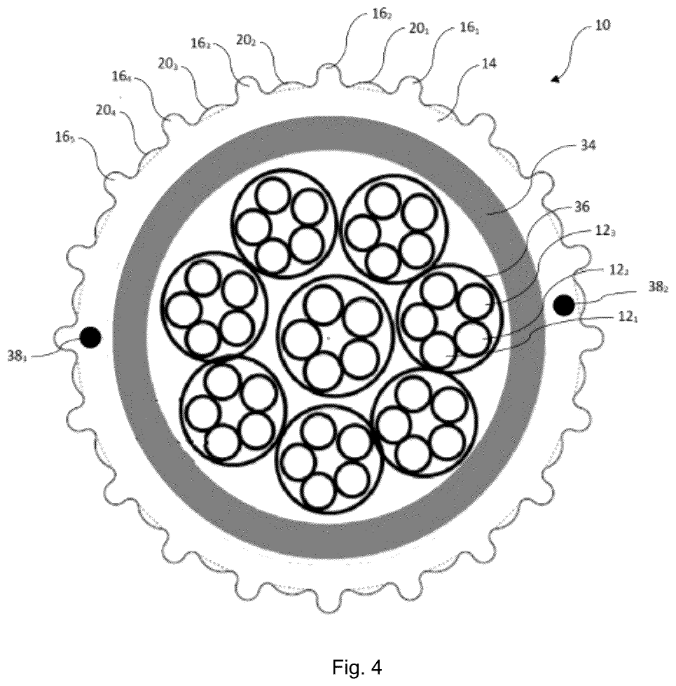

FIG. 4 is a pictorial snapshot illustrating a cross-sectional view of the optical fiber cable in accordance with another embodiment of the present disclosure. The optical fiber cable (10) further comprises a plurality of optical fibers (121, 122, 123, 124). Further, the optical fiber cable (10) comprises one or more additional layers (34) disposed between the one or more optical fibers (12, 121, 122, 123, 124) and the sheath (14).

In accordance with a non-limiting example there may be provided water blocking tape (WBT) (which is a tape used to prevent water ingress into the optical fiber cable. In particular, the water blocking tape ensures that the optical fiber cable remains dry and protects the optical fibers from moisture, which can cause damage and affect performance).

Alternatively, in another non-limiting example there may be provided yarns such as aramid yarns which provide mechanical protection and tensile strength to the optical fiber cable, helping to prevent stretching and breaking.

Alternatively, in yet another non-limiting example there may be provided metal armor layers such as steel tape which provide mechanical strength and protection from rodents.

Alternatively, there may be provided glass roving which are bundles of continuous glass filaments which impart additional strength and protection to the optical fiber cable and provide some amount of safety against electrical interference (as the glass roving have dielectric properties, which means it doesn't conduct electricity and can be used in environments where electrical interference is a concern).

Alternatively, there may be one or more tubes, generally loose tubes that house the optical fibers allowing some movement of the fibers within the tube, which helps protect them from mechanical stresses, such as bending and pulling, that can occur during installation and operation.

In accordance with an embodiment of the invention, the one or more optical fibers (12, 121, 122, 123, 124) comprises one or more loose fibers, one or more optical fiber ribbon, one or more intermittent bonded ribbon optical fibers (36), one or more fibers in one or more loose tubes, one or more fibers in one or more micro modules, one or more tight buffered fibers, one or more bundles of fibers, one or more bundles of optical fiber ribbons, one or more stacks of optical fiber ribbons and one or more bundles of intermittent bonded ribbon optical fibers.

In accordance with an embodiment of the invention, the first height H1 of one or more ribs (161, 162, 163, 164) may vary. Also, the second height of one or more grooves (181, 182, 183, 184) may vary. In a still another embodiment of the invention, the first width W1 of one or more ribs (161, 162, 163, 164) may vary. Also, the second width of one or more grooves (181, 182, 183, 184) may vary.

Further one or more ribs (161, 162, 163, 164) may have a top surface having a semi-circular shape, flat shape, inverted-U shape, arc shape or any other suitable shape. Also, one or more grooves (181, 182, 183, 184) may have a top surface with a semi-circular shape, flat shape, inverted-U shape, arc shape or any other suitable shape.

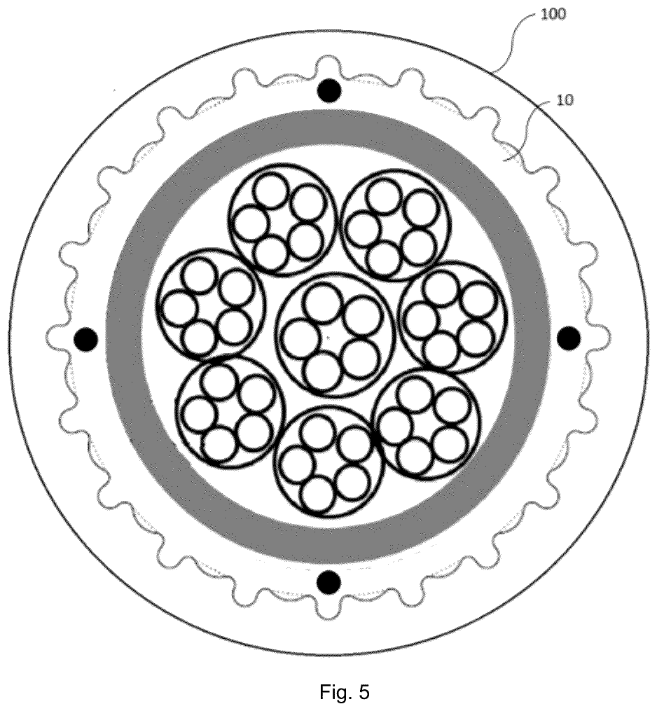

FIG. 5 is a pictorial snapshot illustrating a cross-sectional view of the optical fiber cable of being placed within a duct in accordance with an embodiment of the present disclosure. The optical fiber cable (10) can be installed by air blowing optical fiber cable installation technique within a duct (100) up to a distance of 1500 m with an average speed of about 50 to 60 m/min.

In an embodiment of the invention, the sheath (14) of the optical fiber cable (10) of FIGS. 1-5 may have one or more strength members (38) at least partially embedded in the sheath. The one or more strength members may be made of Aramid Reinforced Plastic (ARP), Fiber Reinforced Plastic (FRP), steel or any other suitable material. The number, size, shape and arrangement of the strength members in the sheath may vary depending on the design requirements.

Advantageously, the optical fiber cable (10) can be installed by air blowing optical fiber cable installation technique within the duct (100) at an air pressure of 50±5 bar with a duct fill ratio (DFR) in the range of 30 to 70% up to a distance of at least 1500 meters at an average speed of at least 50 meters/minute. In particular, it is believed that when DFR is below 30%, large free space is available between the optical fiber cable and the duct. When large space is available, the air force needed to install the cable in the duct increases and poses a challenge in installation. Moreover, it is believed that when DFR is above 70%, the amount of free space available will become substantially less. In this condition, the cable contact area may increase which is un-desired. Also, bending of the optical fiber cable inside the duct becomes a challenge.

Another advantage of the invention is that the protuberant profile (201, 202, 203, 204) substantially in the middle of the one or more grooves (181, 182, 183, 184) at one or more cross-sections of the optical fiber cable (10) tends to reduce a contact area with the duct. Further the protuberant profile (201, 202, 203, 204) substantially in the middle of the one or more grooves (181, 182, 183, 184) at one or more cross-sections of the optical fiber cable (10) ensures that the ribbed sheath fits tightly with the seal of air blowing equipment. Furthermore, the protuberant profile (201, 202, 203, 204) substantially in the middle of the one or more grooves (181, 182, 183, 184) at one or more cross-sections of the optical fiber cable (10) leads to increased drag force of the pressurized air.

In an embodiment of the invention the optical fiber cable may have 3-12 intermittent bonded ribbon (IBR) bundles inside.

In an embodiment of the invention, the optical fiber cable may have 3-12 intermittent bonded ribbon bundles inside and water blocking tape between the IBR bundles and the sheath. It may be noted that the plurality of ribs (161, 162, 163, 164) can have different shapes such as concave, convex, V shape, square shape, rectangle, etc. Now coming to the aspect of method of manufacturing an optical fiber cable,

In accordance with an embodiment of the present invention, the method comprises paying off one or more optical fibers; and extruding a sheath so as to surround the one or more optical fibers (12, 121, 122, 123, 124); the sheath (14) comprising a plurality of ribs (161, 162, 163, 164) and a plurality of grooves (181, 182, 183, 184) on an outer surface and extending along a length of the optical fiber cable (10); the one or more grooves (181, 182, 183, 184) has a protuberant profile (201, 202, 203, 204) at an outer surface of the sheath substantially in the middle of the one or more grooves (181, 182, 183, 184) at one or more cross-sections of the optical fiber cable (10).

In accordance with an embodiment of the present invention, the sheath is extruded at a vacuum pressure of 60±5 mm Hg. The vacuum pressure of 60±5 mm Hg is optimized pressure to form the desired protuberant profile (201, 202, 203, 204) substantially in the middle of the one or more grooves (181, 182, 183, 184) at one or more cross-sections of the optical fiber cable (10).

A person of ordinary skill in the art may be aware that, in combination with the examples described in the embodiments disclosed in this specification, units and algorithm steps may be implemented by electronic hardware, computer software, or a combination thereof.

The foregoing descriptions of specific embodiments of the present technology have been presented for purposes of illustration and description. They are not intended to be exhaustive or to limit the present technology to the precise forms disclosed, and obviously many modifications and variations are possible in light of the above teaching. The embodiments were chosen and described in order to best explain the principles of the present technology and its practical application, to thereby enable others skilled in the art to best utilize the present technology and various embodiments with various modifications as are suited to the particular use contemplated. It is understood that various omissions and substitutions of equivalents are contemplated as circumstance may suggest or render expedient, but such are intended to cover the application or implementation without departing from the spirit or scope of the claims of the present technology.

Disjunctive language such as the phrase “at least one of X, Y, Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

In a case that no conflict occurs, the embodiments in the present invention and the features in the embodiments may be mutually combined. The foregoing descriptions are merely specific implementations of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

What is claimed is:

1. An optical fiber cable (10) comprising
one or more optical fibers (12, 12₁, 12₂, 12₃, 12₄); and
a sheath (14) surrounding the one or more optical fibers (12, 12₁, 12₂, 12₃, 12₄);
wherein the sheath (14) comprising
a plurality of ribs (16₁, 16₂, 16₃, 16₄) and
a plurality of grooves (18₁, 18₂, 18₃, 18₄) on an outer surface and extending along a length of the optical fiber cable (10);
wherein the one or more grooves (18₁, 18₂, 18₃, 18₄) has a protuberant profile (20₁, 20₂, 20₃, 20₄) at an outer surface of the sheath substantially in the middle of the one or more grooves (18₁, 18₂, 18₃, 18₄) at one or more cross-sections of the optical fiber cable (10).

2. The optical fiber cable as claimed in claim 1, wherein one or more pairs of two consecutive ribs (16₁, 16₂, 16₃, 16₄) have at most a first radially inward convex portion (22₁, 22₂, 22₃, 22₄) and a second radially inward convex portion (24₁, 24₂, 24₃, 24₄).

3. The optical fiber cable as claimed in claim 2, wherein the optical fiber cable comprises:
a first outermost points (26₁, 26₂, 26₃, 26₄) of the ribs (16₁, 16₂, 16₃, 16₄) being at a distance from the center of the cable (10) substantially equal to outer radius of the optical fiber cable (10);
the first outermost points (26₁, 26₂, 26₃, 26₄) of the ribs (16₁, 16₂, 16₃, 16₄) being at a first height H1, as taken perpendicular from a line joining a first innermost points (30₁, 30₂, 30₃, 30₄) of the first radially inward convex portion (22₁, 22₂, 22₃, 22₄) of the respective rib (16₁, 16₂, 16₃, 16₄) and a second innermost points (32₁, 32₂, 32₃, 32₄) of the second radially inward convex portion (24₁, 24₂, 24₃, 24₄) of the respective rib (16₁, 16₂, 16₃, 16₄)
a second outermost points (28₁, 28₂, 28₃, 28₄) of the protuberant profile (20₁, 20₂, 20₃, 20₄) of the grooves (18₁, 18₂, 18₃, 18₄) being at a second height H2, as taken perpendicular from the line joining the first innermost points (30₁, 30₂, 30₃, 30₄) of the first radially inward convex portion (22₁, 22₂, 22₃, 22₄) of the respective groove (18₁, 18₂, 18₃, 18₄) and the second innermost points (32₁, 32₂, 32₃, 32₄) of the second radially inward convex portion (24₁, 24₂, 24₃, 24₄) of the respective groove (18₁, 18₂, 18₃, 18₄);
a first width of the plurality of ribs (16₁, 16₂, 16₃, 16₄) being W1, as length of the line joining a first innermost points (30₁, 30₂, 30₃, 30₄) of the first radially inward convex portion (22₁, 22₂, 22₃, 22₄) of the respective rib (16₁, 16₂, 16₃, 16₄) and a second innermost points (32₁, 32₂, 32₃, 32₄) of the second radially inward convex portion (24₁, 24₂, 24₃, 24₄) of the respective rib (16₁, 16₂, 16₃, 16₄);
a second width of the plurality of grooves (18₁, 18₂, 18₃, 18₄) being W2, as length of the line joining the first innermost points (30₁, 30₂, 30₃, 30₄) of the first radially inward convex portion (22₁, 22₂, 22₃, 22₄) of the respective groove (18₁, 18₂, 18₃, 18₄) and the second innermost points (32₁, 32₂, 32₃, 32₄) of the second radially inward convex portion (24₁, 24₂, 24₃, 24₄) of the respective groove (18₁, 18₂, 18₃, 18₄); and
a number of grooves (18₁, 18₂, 18₃, 18₄) being N1.

4. The optical fiber cable as claimed in claim 3, wherein a ratio between outer radius of the cable (10) and W2 being in the range of 5 to 8.

5. The optical fiber cable as claimed in claim 3, wherein the second height H2 corresponding to the second outermost points (28₁, 28₂, 28₃, 28₄) of the protuberant profile (20₁, 20₂, 20₃, 20₄) of the grooves (18₁, 18₂, 18₃, 18₄) is in the range of 0.08 to 0.14 mm.

6. The optical fiber cable as claimed in claim 3, wherein the first height H1 corresponding to the first outermost points (26₁, 26₂, 26₃, 26₄) of the ribs (16₁, 16₂, 16₃, 16₄) is in the range of 0.2 to 0.3 mm.

7. The optical fiber cable as claimed in claim 3, wherein a ratio between N1 and outer radius of the cable (10) being in the range of 2.4 to 4.

8. The optical fiber cable as claimed in claim 3, wherein a ratio between outer radius of the cable (10) and W1 being in the range of 7 to 9.

9. The optical fiber cable as claimed in claim 1, wherein the one or more optical fibers (12, 12₁, 12₂, 12₃, 12₄) comprise one or more loose fibers, one or more optical fiber ribbon, one or more intermittent bonded ribbon optical fibers, one or more fibers in one or more loose tubes, one or more fibers in one or more micro modules, one or more tight buffered fibers, one or more bundles of fibers, one or more bundles of optical fiber ribbons, and one or more bundles of intermittent bonded ribbon optical fibers.

10. The optical fiber cable as claimed in claim 1, comprising one or more additional layers disposed between the one or more optical fibers (12, 12₁, 12₂, 12₃, 12₄) and the sheath (14).

11. The optical fiber cable as claimed in claim 9, wherein the one or more bundles of intermittent bonded ribbon optical fibers are bound by one or more water swellable binders.

12. The optical fiber cable as claimed in claim 1, wherein the cable can be installed by air blowing installation technique within the duct (100) at an air pressure of 50±5 bar with a duct fill ratio (DFR) in the range of 30 to 70%.

13. A method of manufacturing an optical fiber cable, characterized in that steps of:
paying off one or more optical fibers; and
extruding a sheath so as to surround the one or more optical fibers (12, 12₁, 12₂, 12₃, 12₄); the sheath (14) comprising a plurality of ribs (16₁, 16₂, 16₃, 16₄) and a plurality of grooves (18₁, 18₂, 18₃, 18₄) on an outer surface and extending along a length of the optical fiber cable (10);
wherein the one or more grooves (18₁, 18₂, 18₃, 18₄) has a protuberant profile (20₁, 20₂, 20₃, 20₄) at the outer surface of the sheath substantially in the middle of the one or more grooves (18₁, 18₂, 18₃, 18₄) at one or more cross-sections of the optical fiber cable (10).

14. The method as claimed in claim 13, wherein one or more pairs of two consecutive ribs (16₁, 16₂, 16₃, 16₄) have at most a first radially inward convex portion (22₁, 22₂, 22₃, 22₄) and a second radially inward convex portion (24₁, 24₂, 24₃, 24₄).

15. The method as claimed in claim 13, wherein the sheath is extruded at a vacuum pressure of 60±5 mm Hg.

16. The method as claimed in claim 13, wherein a ratio between outer radius of the cable (10) and W2 being in the range of 5 to 8.

17. The method as claimed in claim 13, wherein the second height H2 corresponding to the second outermost points (28₁, 28₂, 28₃, 28₄) of the protuberant profile (20₁, 20₂, 20₃, 20₄) of the grooves (18₁, 18₂, 18₃, 18₄) is in the range of 0.08 to 0.14 mm.

18. The method as claimed in claim 13, wherein the first height H1 corresponding to the first outermost points (26₁, 26₂, 26₃, 26₄) of the ribs (16₁, 16₂, 16₃, 16₄) is in the range of 0.2 to 0.3 mm.

19. The method as claimed in claim 13, wherein a ratio between N1 and outer radius of the cable (10) being in the range of 2.4 to 4.

20. The method as claimed in claim 13, wherein a ratio between outer radius of the cable (10) and W1 being in the range of 7 to 9.
